(19) United States
(12) Patent Application Publication
(10) Pub. No.: US 2020/0111371 A1
(43) Pub. Date: Apr. 9, 2020

(54) MANAGEMENT OF ASYNCHRONOUS FLIGHT MANAGEMENT SYSTEMS

(71) Applicant: THALES, COURBEVOIE (FR)

(72) Inventors: Michel ROGER, TOULOUSE (FR); Frédéric BONAMY, MERIGNAC (FR); François NEFFLIER, TOULOUSE (FR)

(21) Appl. No.: 16/592,628

(22) Filed: Oct. 3, 2019

(30) Foreign Application Priority Data
Oct. 4, 2018 (FR) 1801049

(51) Int. Cl. G08G 5/00; G05D 1/00; B64C 39/02

(52) U.S. Cl. CPC G08G 5/003; B64C 2201/12; B64C 39/024; G05D 1/0027

(57) ABSTRACT

A method for the remote piloting, with latency, of a remotely piloted aircraft, notably includes the steps of: receiving a position in space of the remotely piloted aircraft in a first flight management system or FMS; determining at least one lock point V on the flight plan at a later position than the said position; locking the path and/or the flight plan of the remotely piloted aircraft as far as V. Developments describe the communication and implementation of an amendment in an onboard second FMS, notably the prevention or the postponement of an amendment before or beyond V, the adjustment of the distance between the current position and V as a function of the speed and of the cumulative latency time, of the conditions of validity, of the options to display and to offset point(s) continuously, etc. Software and system aspects (fleets of land, sea, underwater, space, etc. systems) are described.

### CROSS-REFERENCE TO RELATED APPLICATIONS

This application claims priority to foreign French patent application No. FR 1801049, filed on Oct. 4, 2018, the disclosure of which is incorporated by reference in its entirety.

### FIELD OF THE INVENTION

The invention relates to the field of the flight management of an aircraft. In particular, it relates to the management of asynchronous flight management systems, for example in the context of the remote piloting of a drone.

### BACKGROUND

A modification to a flight plan or to the path of an aircraft generally applies with a local and therefore practically immediate (or at least very short-term) effect on the path of this craft. This may be acceptable in an aircraft piloted by a human being who is on board the aircraft, who may if necessary correct or adapt its path, or in a fully autonomous drone.

In the case of fully or partially remotely piloted aircraft, there are various latency times that may accumulate and, as a result of this, there are a number of technical problems that may arise, particularly as a function of the speed of the craft considered.

In the case of drones or aeroplanes, the latency may in fact range up to several seconds. The remote control of Curiosity on Mars should compile with 13 minutes of latency. Even in the case of a latency that is short (e.g. a few microseconds) in absolute terms, if the speed of the aircraft is very high (e.g. supersonic or hypersonic), the short-term remote-controllability of the aircraft may become problematic.

The overall latency is in fact a combination of numerous latencies and delays: delays in transmission (generally brief), in signal processing (variable), in security mechanisms, e.g. encrypting and decrypting data (of the order of 3 to 6 seconds depending on the complexity thereof, involving carrying out various verification processes), etc.

The cumulative latency (which very often cannot be shortened) delays the actual implementation of a modification desired remotely. Because these delays combine, the position of the craft may have changed significantly in the meantime, i.e. may differ significantly from the position at which the desired modification to the flight was determined. The modification, were it to be implemented (e.g. confirmed by the ground or by the remote operator), would then use an erroneous position if it were applied locally to the aircraft.

Regulatory constraints also specify a cap in the total duration (between the moment at which a modification is initialized and the moment at which its result is visible to the remote operator). In certain situations, this constraint is difficult to comply with, particularly when the asynchronism diverges or becomes significant.

The existing literature does not really describe satisfactory solutions to this initial technical problem (or to other technical problems derived from it).

There is a need within industry for advanced systems and methods for managing the synchronism of a plurality of FMSs, particularly in the case of a remotely piloted aircraft.

### SUMMARY OF THE INVENTION

The invention relates to a method for the remote piloting, with latency, of a remotely piloted aircraft, notably comprising the steps of: receiving a position in space of the remotely piloted aircraft in a first flight management system or FMS; determining at least one lock point V on the flight plan at a later position than the said position; locking the path and/or the flight plan of the remotely piloted aircraft as far as V. Developments describe the communication and implementation of an amendment in an onboard second FMS, notably the prevention or the postponement of an amendment before or beyond V, the adjustment of the distance between the current position and V as a function of the speed and of the cumulative latency time, of the conditions of validity, of the options to display and to offset point(s) continuously, etc. Software and system aspects (fleets of land, sea, underwater, space, etc. systems) are described.

The invention may advantageously apply to various situations encountered in the field of aeronautics. For example, a manned aircraft may have “lost” its pilot (who for some reason may be incapable of piloting the craft) but may remain remotely pilotable. In another situation, the pilot may be absent (e.g. on a rest, temporarily absent, etc.) so that the craft is remotely piloted from the ground and/or from another aircraft. In another situation, an aircraft in difficulty, which has deviated from its flight plan, may request a remote-control takeover (considering particular terrain or meteorological data). In another situation, the taking-over of control may be forced from the ground (by means of suitable security mechanisms). In certain situations, an aircraft may control another aircraft (e.g. escort or hacking), for example in the event of downgraded communications between ground systems (airline operating centre, AOC, or air traffic control ATC) and onboard systems. The downgraded conditions may for example have been brought about by saturation of the network (or by a need for more security, dictating an encryption/decryption of the information exchanged).

In reality, by extension, the invention can apply to any other type of (at least partially) “remotely piloted vehicle”; whether this be a land, sea, underwater or even space vehicle. As a generalization, the invention may apply to any remotely piloted vehicle that exhibits latency between the sending of a command and the application of this command to the previously defined path.

Advantageously, the invention corrects problems associated with the latency in the communication on the position of the moving vehicle and in that respect differs from approaches centred on “monitoring”.

Advantageously, the invention allows a guarantee that the path produced and followed by the aircraft is the same as the one produced remotely (for example on the ground).

Advantageously, and specifically in the aeronautical domain, the invention takes account of the various possible amendments that can be applied to the current position of the moving vehicle, notably DIRECT TO, HOLD and OFFSET.

In general, the invention may be compatible with partially (i.e. not entirely) autonomous systems, notably those having local reflex arcs, e.g. rapid changes in path such as anti-collision or collision-avoidance mechanisms (avoiding a bird or an artificial or natural obstacle at low altitude, etc.). If appropriate, the aircraft may quickly rejoin the intended path and notably continues to apply the steps of the method according to the invention.

### BRIEF DESCRIPTION OF THE DRAWINGS

Further features and advantages of the invention will become apparent from the following description and from the figures of the attached drawings in which:

FIG. 1 illustrates one example of a technical problem that arises in the matter of remote piloting;

FIG. 2 schematically illustrates the structure and functions of a flight management system of FMS type;

FIG. 3 illustrates one example of the processing applied to a request to amend the flight plan according to one embodiment of the invention;

FIG. 4 illustrates one example of the updating of the position of the remotely piloted aircraft according to one embodiment of the invention.

### DETAILED DESCRIPTION

Depending on the embodiments of the invention, a “remotely piloted aircraft” may be a drone, or a commercial airliner, or a cargo plane, or else even a helicopter, which may or may not be carrying passengers.

A “remotely piloted aircraft” may or may not be “manned”. A “remotely piloted aircraft” may be partially autonomous. For example, in the future, an aircraft piloted by a single human pilot, as opposed to the two there are nowadays, may comprise mechanisms for remote takeover of control, in full or in part (during certain phases of flight, for example, or in the event of the pilot becoming incapacitated). Remote control may be performed by a machine (i.e. algorithms or a predefined logic) and/or by man (a single remote operator or a communal decision by pilots on the ground).

A “drone” or UAV (unmanned aerial vehicle) is an unmanned aircraft which may or may not be remotely piloted. The performance, size, autonomy, cost of operation and procurement cost of a drone can vary widely. Certain drones measure just a few centimetres (for example the micro UAV drones inspired by biomimetics) while others (e.g. observation drones) reach a wingspan of as much as several metres. A drone generally comprises flight stabilization methods and devices (and/or reflex arcs). As for drone flight plans, while these may sometimes be wholly predefined, they are generally at least partially remotely guided by a human operator.

More generally, the term “aircraft” in the description below may be replaced by the terms vehicle, car, truck, bus, train, motorbike, boat, robot, submarine, toy, etc. or any element having the capability of being remotely piloted (through a radio, satellite or other link), at least partially (intermittently, or periodically, or even opportunistically over the course of time). Remote piloting may be full or partial (limited to certain functions, having a direct or indirect impact on the path) when the control system (logic) is (even a little) disconnected from the (physical) drive system. For example, the invention may be advantageous in certain situations of automated motorcar driving (e.g. in an urban environment at a crossroads where the paths are open, with fewer constraints than on a carriageway running in a single direction). The control centre for its part may itself be distributed, and this may be in a non-static manner (e.g. roles circulating in a fleet of controlled cars or trucks).

Described here is a method for the remote piloting of a remotely piloted aircraft, comprising the steps consisting in: — receiving a position in space of the remotely piloted aircraft in a first flight management system or FM1; — determining a lock point (or several points) on the flight plan at a later position than the said position by the said FM1, — locking the path and/or the flight plan of the remotely piloted aircraft as far as the lock point (or at least one of the plurality that have been determined) by the said FM1.

An aircraft follows a path calculated from a flight plan. An aircraft may have several degrees of freedom (a helicopter can “reverse”). Even though circuits or going back are possible in the short term (e.g. helicopter, quadcopter, n-copter drone, etc.) or in the longer term (e.g. aeroplane), the path followed by the aircraft runs in the direction of the arrow of time, i.e. with an “earlier” (past), a current (present) and a “later” (future) position.

The “lock point” may also be referred to as a “later point” or “point ahead” or “deferred point”.

One or more lock points may be defined. Each segment or “leg” between the lock points may be associated with one or more modification conditions (e.g., all modifications forbidden; one or more types of amendment authorized; one or more authorized exceptions, etc.).

In one embodiment, the step consisting in locking the path and/or the flight plan of the remotely piloted aircraft as far as the (deferred) locked flight plan point comprises a step consisting in preventing any amendment to the flight plan coming into effect before the position of the lock point and/or in postponing the implementation of any request to amend the flight plan beyond the lock point.

Depending on the embodiments, the term “prevent” may be replaced by “eliminate”, “cancel” or “ignore” or “inhibit”. The term “postpone” may be replaced by “defer” or “delay” or “regulate” or “offset”. In one embodiment, implementation of an amendment may take place at the moment of passing the lock point (lock point included). In one embodiment, implementation of an amendment may take place “beyond” or “onwards from” the passing of the lock point (lock point not included).

In one embodiment, the method further comprises a step consisting in communicating, to the onboard flight management system or FM2 of the remotely piloted aircraft, the position of the said lock point and/or an amendment to the flight plan from the lock point onwards. The flight plan amendment may be an amendment decided upon on the ground and delayed or deferred.

In one embodiment, the amendment is of the DIRECT TO, HOLD, or OFFSET type, or is an amendment that modifies the path of the aircraft right from its current position. This regards any amendment that modifies the active leg.

In one embodiment, the distance between the current position of the remotely piloted aircraft and the lock point covers at least the latency time between the sending of a flight command and the actual implementation of same.

The locking by flight plan point(s) may notably be performed while taking account of the latency (peak, i.e. maximum, or mean latency or latency according to other descriptive statistical parameters).

The latency time between the sending of a flight command and the actual implementation of same is the cumulative latency time, namely including all delays of all kinds (communication, signal processing, encryption/decryption, security, checks, etc.). This cumulative latency time may effectively be measured continuously. It can be extrapolated or estimated regarding the future.

In one embodiment, the method further comprises steps consisting in receiving or determining the cumulative remote piloting latency; receiving or determining the speed of the remotely piloted aircraft at its position in space; the distance between the position in space of the remotely piloted aircraft and the later deferred point being determined as a function of the cumulative latency (with the possible addition of a margin of safety) and/or as a function of the speed of the aircraft.

The margin of safety makes it possible to cover any risk of a latency that is longer than anticipated. The higher the speed (hypersonic), the greater the margin of safety.

In one embodiment, the distance is fixed or all-inclusive.

In one embodiment, as the latency time is known, as is the speed, a minimum distance to which an (“all-inclusive”) margin of safety is added can be determined so as to be able to check the path or the flight plan of the aircraft at certain points.

In one embodiment, the distance is (a) function of the speed of the aircraft and of the cumulative latency time.

In one embodiment, the function is an analytical function. In other embodiments, the determination uses algorithms, determined according to graphs, or heuristics, or else is even decided upon unilaterally by a remote operator.

In one embodiment, the level of encryption involved in the cumulative latency is adjusted (reduced or, respectively, increased) so as to reduce (or, respectively, to increase) the said latency, in order to lock one or several points of the flight plan that are less (or respectively more) distant from the current position of the aircraft. In one embodiment, in effect, the latency itself can be manipulated (reduced and/or increased). For example, the level of encryption may be adjusted dynamically, according to various parameters (e.g. position, action, risks of interception, etc.). This is because decrypting (pirating, hacking) effectively requires computation resources and therefore time, which can be estimated. According to certain circumstances (e.g. low altitude flight, rapid action), the level of encryption may be temporarily reduced in order to shorten the cumulative latency time and be able to lock points closer to the current position.

In one embodiment, the lock point is associated with one or several validity intervals or is continuously offset as a function of the movement of the aircraft.

A validity interval may be (pre)defined in time and/or in space. For example, a lock point may remain in place in space and once passed by the aircraft becomes inactive or inoperative (the remote operator can then create one or more new lock points). In other embodiments, the remote operator may save himself the trouble of recreating such points by defining, for example, a “sliding” lock point which remains active or valid according to time (duration, time tabling, etc.) and/or space (e.g. after a given flight plan point the lock point is no longer active, etc.) conditions.

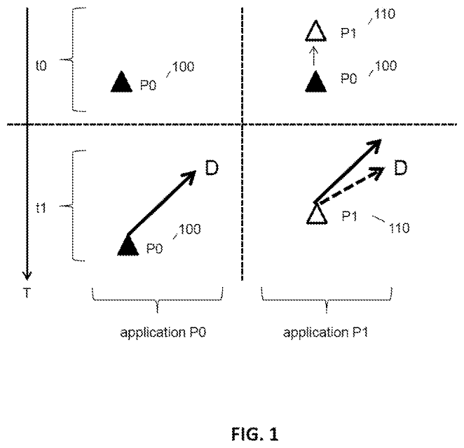

FIG. 1 illustrates one example of a technical problem that arises in the matter of remote piloting.

The position P0 (100), known at every moment t0 by a system on the ground, for example by a remote operator, is, in the example, delayed with respect to the actual position P1 (110) of the moving vehicle. P0 is known from the ground. P1 is known onboard.

This delay can be explained, for example, by the latencies induced by the transmission and encryption/decryption times between the moving vehicle and its distant control system, delays in transmission, verification processes, etc.

When confronting this problem there are two possible solutions. Either the calculation takes account of the position P0 (100) which is known by the remote system, or it takes account of the actual position P1 (110) of the moving vehicle and imposes this on the calculations performed locally in the drone (and in the control station). However, these two solutions present problems. The associated paths may differ. For example, if the moving vehicle is ahead, it may find itself out of the path finally defined. It will be noted that the type of calculation may vary. One calculation performed may notably be a DIRECT TO amendment, a HOLD amendment or an OFFSET amendment.

More specifically, in the current field of aeronautics, the flight management system comprises at least two FM (flight management) applications. These applications are independent for performing position, prediction and guidance calculations. The DIRECT TO amendment is an amendment that can be applied to the current position of a moving vehicle. Even though the onboard FMs are “living” in near synchronous contexts, there are two concepts implemented for this function: (1) the path is updated with the movement of the moving vehicle as long as the modification is not inserted into the active flight plan and (2) when the DIRECT TO is inserted, the first FM sends the DIRECT TO insertion command to the other FM, accompanying it with its own position of the moving vehicle in order to ensure that the same path is produced. The problem with this solution is that it no longer works if the asynchronism between the 2 FMs becomes significant. This approach no longer works if the latency is significant.

In a context in which an aircraft carries its own onboard FM, and the ground station of the remote pilot is equipped with another FM, a communication latency arises in this instance and may represent several seconds (typically 2 to 3 seconds). With two sets of FM, one on the ground and the other in flight, the modification may be initialized onboard or on the ground. This being the case, applying an amendment to the path which begins from the current position of the moving vehicle is going to lead to the following problems according to the point at which the action is initialized.

(a) if the command is processed by the FM on the ground, then the amendment is initialized on the ground, the ground FM executes the modification then the ground FM asks the onboard FM also to execute the modification. At this stage, the two paths may already be different or diverging because they start at two spatial positions that are offset by the latency time. In order not to create different context, the ground FM will generally provide the information regarding the position of the aircraft at which it performed the modification during the DIRECT TO insertion. In this setup, the problem lies in the fact that the actual position of the aircraft may be offset from (for example ahead or later than) the position supplied by the ground. The path followed by the aircraft may potentially be different from that produced on the ground. This is the anomaly most feared by operators who may consider that the moving vehicle is not following the path produced on the ground and that the moving vehicle is behaving in a way that the remote pilot might not expect.

(b) if the command is processed by the onboard FM, the amendment is initialized on the ground and the ground FM sends the modification to the onboard FM. The onboard FM executes the modification and asks the ground FM to execute the modification. Once again, at this stage, the two paths may already differ because they start from two positions that are offset by the latency time. In order not to create different context, the onboard FM will supply the position at which it performed the modification during insertion of the command (e.g. of the DIRECT TO). The problem this time lies in the waiting time. Between the moment at which the modification was initialized and its impact was seen, twice the latency time will have elapsed. If the latency time is 3 seconds, the result of the operation will not be visible until the end of 6 seconds, which does not conform to the regulations (which, for example, demand that the result of a DIRECT TO amendment be visible to the pilot in under 1 second).

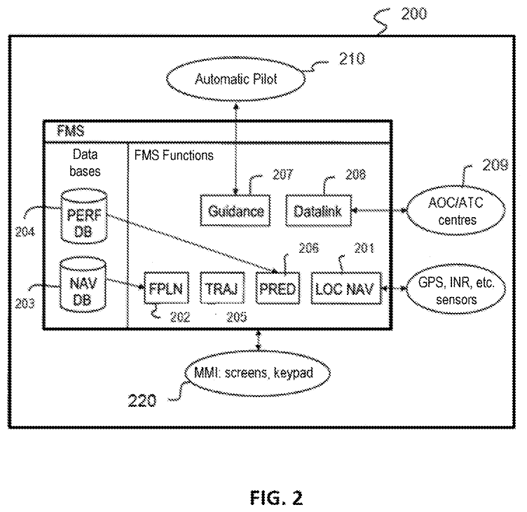

FIG. 2 schematically illustrates the structure and functions of a flight management system of FMS type;

FIG. 2 schematically illustrates the structure and functions of a known flight management system of FMS type. An FMS-type system 200 installed in the cockpit 120 and the avionic means 121 has a man-machine interface 220 comprising input means, for example formed by a keypad, and display means, for example formed by a display screen, or else simply a touchscreen, as well as at least the following functions:
navigation (LOCNAV) 201, for optimally locating the aircraft according to geolocation means 230 such as satellite positioning systems or GPS, GALILEO, VHF radio navigation beacons, inertial units. This module communicates with the aforementioned geolocation devices;
flight plan (FPLN) 202, for capturing the geographical elements that make up the “bare bones” of the route that is to be followed, such as the points dictated by the departure and arrival procedures, the waypoints, and the airways. The methods and systems described relate to or affect this part of the computer;
navigation database (NAVDB) 203, to construct geographical routes and procedures from data included in the databases relating to the points, beacons, altitude or intercept legs, etc.;
performance database (PERFDB) 204, containing parameters pertaining to the aerodynamic performance and engines of the craft;
lateral trajectory (TRAJ) 205, to construct a continuous path from the points in the flight plan, conforming to the aircraft performance and required navigational performance (RNP);
predictions (PRED) 206, for constructing a vertical profile optimized on the lateral trajectory and giving estimates of distance, time, altitude, speed, fuel and wind notably at each point, at each change in navigation parameter and at the destination, which will be displayed to the air crew. The methods and systems described chiefly relate to or affect this part of the computer.
guidance (GUID) 207, for guiding the aircraft in the lateral and vertical planes on its three-dimensional path while optimizing its speed, using the information calculated by the predictions function 206. In an aircraft equipped with an automatic pilot device 210, the latter may exchange information with the guidance module 207;
digital data link (DATALINK) 208 for exchanging flight information between the flight plan/predictions functions and the control centres or other aircraft 209; several peripheral input screens for interacting with the pilot and for displaying the paths and other calculation results.

From the defined flight plan (the list of “waypoints”) and procedures (departure, arrival procedures, airways, missions), the 3D path is calculated as a function of i) the geometry between the waypoints (commonly referred to as LEGs), ii) the performance of the aeroplane and the constraints in the flight plan (altitude, speed, time, climb/descent angle).

From position sensors available on the aeroplane (GPS, inertial units IRS, radio beacon receiver VOR, DME, etc.), the FM of each aircraft or drone establishes a 3D position.

From the calculated 3D path and the established 3D position, the FMS of each aircraft or drone formulates, on each of the lateral, vertical and longitudinal axes, guidance instructions which ensure that the remotely piloted aircraft automatically follows the path.

In the conventional way, all of the FMs carried onboard the one same moving vehicle are near synchronous and produce identical paths.

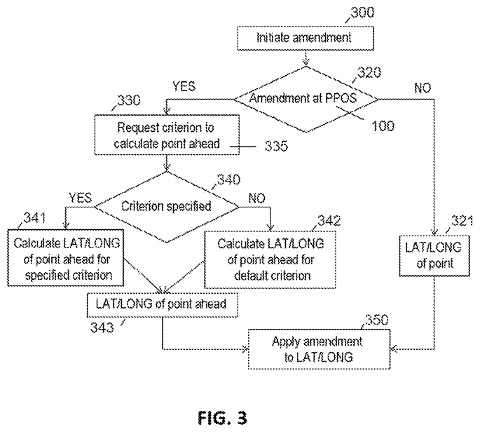

FIG. 3 illustrates an example of the processing applied to a request to amend the flight plan according to one embodiment of the invention.

A request or demand to amend the flight plan of the aircraft is received in step 310. Step 320 determines whether this amendment affects the current point. If it does not, the latitude and longitude information is transmitted and the amendment is applied in step 350 to the designated point. If the amendment affects the current point, step 330 determines the position of a deferred point 335, using a criterion, which criterion may be specified 341 or not specified 342. If the criterion is not specified, the criterion used for the calculation in step 342 is a criterion predefined by default.

Depending on the embodiment, there are a number of ways of determining the position in space of the deferred point 335. Use may be made of an all-inclusive distance that is fixed, or that can be modified by the remote operator. Use may also be made of a distance that is a function of the speed of the aircraft, for example during an all-inclusive duration (current speed or max speed or speed specified by the pilot) and/or as a function of the measured communications delay (measured latency), corrected by an additional delay to take account of jumps in network load. This delay may, for example, correspond to the measured maximum delay or to the measured mean.

In one embodiment, this deferred point 335 may remain at a fixed or unvarying position once it has been calculated. In one embodiment, the deferred point may “move” at the same time as the aircraft. Its fixed position then being established at the time of insertion of the modification.

Whatever the type of exchange between the ground FM and the onboard FM, the deferred point will have a position that is defined in terms of latitude and longitude.

If the exchange is in the form of a flight plan, the deferred point may be a point on the flight plan which will be transmitted after the modification has been validated.

If the exchange is in the form of a command, then the command may also include the position (latitude, longitude) onwards of which the amendment is to be applied.

This later deferred point may advantageously also be communicated to a third party system capable of calculating a flight plan or a path and of supplying it to the aircraft.

In certain embodiments, the deferred point 335 will be far enough away that it will not be reached before the modification has been validated and/or not too far away, so as not to perturb whoever requested the change in path and who will see the remotely piloted aircraft continue on its old path (for example in the case of line of sight control).

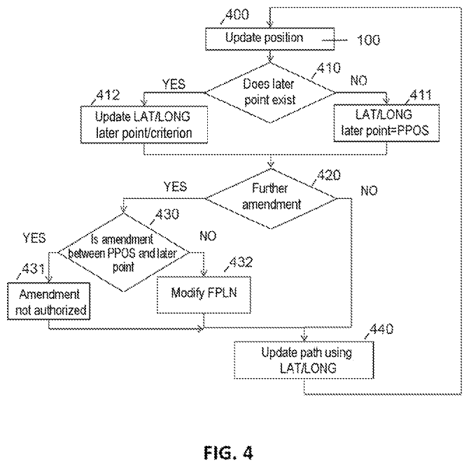

FIG. 4 illustrates one example of the updating of the position of the remotely piloted aircraft according to one embodiment of the invention.

This figure illustrates the dynamic aspect of the invention, i.e. the way the moving vehicle moves as long as the modification has not been validated. Using the same approach as is taken for DIRECT TO, HOLD and OFFSET amendments, the position of the deferred point may be updated over the course of time (periodically, non-periodically, intermittently, on demand, in response to an event, randomly, opportunistically, etc.).

In one embodiment, the position 100 is updated in step 400. If a deferred point exists (step 410) then the deferred point may in its turn be updated 412; otherwise (in the general case) a deferred point 335 is determined. If then an amendment to the flight plan is received 420, then step 430 determines whether the amendment affects the path between the current point and the deferred point; if appropriate, the amendment is not authorized 431; otherwise the amendment is implemented and the flight plan is modified 432. Finally, the path is updated 440.

Also described is a computer program product, the said computer program comprising code instructions configured to carry out one or several of the steps of the method, when the said program is executed on a computer.

Also described is a system for implementing one or several of the steps of the method, the said system comprising at least two flight management systems FMS, each FMS being on the ground or in flight. There are a number of possible configurations: both FMSs are in flight, one FMS is on the ground while the other is in flight, both are on the ground (remotely piloted robot).

In one embodiment, the system comprises one or several remotely piloted FMSs and one or several remotely piloting FMSs.

In general, there are various possible configurations. In one configuration, 1*FMS1 remotely pilots 1*FMS2: e.g. a remote operator on the ground or in flight remotely pilots a remotely piloted drone. In one configuration, 1*FMS1 remotely pilots N*FMS2: e.g. one remote operator and N “synchronized” or independent drones. In one configuration, N*FMS1 remotely pilots 1*FMS2: e.g. a plurality of stations take turns at remotely piloting, or take communal decisions (e.g. votes, distributed consensus, etc.) regarding a given craft. In one configuration, N*FMS1 manages N*FMS2: e.g. a plurality of stations pilot a plurality of drones; in one embodiment, the role of the remote operator may notably be a “circulating” one, i.e. may change host over the course of time. A fleet (or a cluster or a mass or a swarm) of aerial drones may thus move (circulating roles), for example minimizing the total sum of the latencies from point to point, or with the centre of the fleet governing the periphery (or vice versa).

The invention may be implemented using hardware (for example ASIC and/or FPGA) and/or software components. It may be available as a computer program product on a computer readable medium. In one alternative form of embodiment, one or more steps of the method according to the invention are implemented in the form of a computer program hosted on a portable computer of the EFB (electronic flight bag) type and/or within a computer of FMS type (or in an FM function of a flight computer).

1. A method for the remote piloting of a remotely piloted aircraft, comprising the steps consisting in:
receiving a position in space of the remotely piloted aircraft in a first flight management system or FM1,
determining a lock point on the flight plan at a later position than the said position by the said FM1;
locking the path and/or the flight plan of the remotely piloted aircraft as far as the lock point by the said FM1.

2. The method according to claim 1, wherein the step consisting in locking the path and/or the flight plan of the remotely piloted aircraft as far as the lock point comprises a step consisting in preventing any amendment to the flight plan coming into effect before the position of the lock point and/or in postponing the implementation of any request to amend the flight plan beyond the lock point.

3. The method according to claim 1, further comprising a step consisting in communicating, to the onboard flight management system or FM2 of the remotely piloted aircraft, the position of the said lock point and/or an amendment to the flight plan from the lock point onwards.

4. The method according to claim 2, the amendment being of the DIRECT TO, HOLD, or OFFSET type, or being an amendment that modifies the path of the aircraft right from its current position.

5. The method according to claim 1, the distance between the current position of the remotely piloted aircraft and the lock point covering at least the latency time between the sending of a flight command and the actual implementation of same.

6. The method according to claim 5, the distance being fixed or all-inclusive.

7. The method according to claim 5, the distance being a function of the speed of the aircraft and of the latency time between the sending of a flight command and the actual implementation of same.

8. The method according to claim 1, the lock point being associated with one or several validity intervals or being continuously offset as a function of the movement of the aircraft.

9. The method according to claim 5, the level of encryption involved in the latency being adjusted so as to reduce or to increase the said latency, in order to lock one or several points on the flight plan that are less or more distant from the current position of the aircraft.

10. A computer program product, the said computer program comprising code instructions configured to carry out the steps of the method according to claim 1, when the said program is executed on a computer.

11. A system for implementing the steps of the method according to claim 1, the said system comprising at least two flight management systems FMS, each FMS being on the ground or in flight.

12. The system according to claim 11, comprising one or several remotely piloted FMSs and one or several remotely piloting FMSs.
